(19) United States
(12) Patent Application Publication
(10) Pub. No.: US 2005/0064906 A1
(43) Pub. Date: Mar. 24, 2005

(54) Radio communication system and method for the operation thereof

(76) Inventors: Jochen Metzler, Mainz (DE); Thomas Reim, Balzheim (DE)

Correspondence Address: STAAS & HALSEY LLP, SUITE 700, 1201 NEW YORK AVENUE, N.W., WASHINGTON, DC, 20005, US

(21) Appl. No.: 10/497,207

(22) PCT Filed: Nov. 29, 2002
(86) PCT No.: PCT/EP02/13525

(30) Foreign Application Priority Data
Nov. 29, 2001 (EP) 01128548.3
Nov. 29, 2001 (DE) 10158616.7

(51) Int. Cl. H04B 1/38

(52) U.S. Cl. 455/560; 455/422.1; 370/466; 370/401

(57) ABSTRACT

In a radiocommunication system a first network element supports connection-oriented communication and is identified by a first address in a first format. A second network element supports connectionless communication and is identified by a second address in a second format. A network transmission unit and a data bank are also part of the radiocommunication system. To establish a connection between the first network element and the second network element, a connection-oriented link is set up between the network transmission unit and the second network element. Addresses in the first format are converted into the second format with the aid of the data bank.

### CROSS REFERENCE TO RELATED APPLICATIONS

The application is based on and hereby claims priority to German Application No. 10158616.7 and European Application No. 01128548.3, both filed on Nov. 29, 2001, the contents of both of which are hereby incorporated by reference.

### BACKGROUND OF THE INVENTION

Radio communication systems are used for transmission of information, voice or data with the aid of electromagnetic waves over a radio interface, also called an air interface, between a sending and a receiving radio station. Radio communication systems can be subdivided into a core net and a Radio Access Network, also abbreviated to RAN. In the core network payload and signaling data is transported to a plurality of terminals over long distances. In addition a connection can be implemented between the core net and a fixed communication network. In the radio access network data received by the terminals is converted into a format suitable for transmission in the core net. Further the format of data received by the core net is adapted to radio transmission and forwarded to the relevant radio station within the transmission zone of which the relevant terminal is located.

First and second-generation radio communication systems are currently in use around the world and, because of the great demand for mobile communication, are reaching the limits of their capacity. The capacity problems which have emerged are to be resolved by the radio communication systems of the third generation. One of the most promising of the third-generation radio communication systems is the Universal Mobile Telecommunication System (UMTS) which was specified by the 3GPP (Third Generation Partnership Project) standardization body (see for example B. Walke, Mobilfunknetze and ihre Protokolle, (Mobile Radio Networks and their Protocols) Volume 1, Pages 385 to 387, Teubner-Verlag 2000).

Data is transmitted in the UTRAN access network specified for UTMS by connection-oriented communication using the ATM procedure. In this procedure the data which is to be transmitted over a connection is subdivided into ATM cells. The ATM cells for a plurality of connections are nested within one another and transmitted over the same physical connection. The connection channel in this case remains the same for the duration of the data transmission. An overview of the ATM procedure can be found for example in B. Walke, Mobilfunknetze and ihre Protokolle, Volume 2, Chapter 9, Pages 291 to 326, Teubner-Verlag 2000.

The demand for worldwide data communication with high bandwidth is increasing in parallel with the requirement for mobile communication. This data communication is undertaken over the Internet using IP (Internet Protocol) communication. It involves the transfer of data packets over packet-oriented connections, meaning connectionless communication, between the subscribers. With packet-oriented transmission the connection channel between the subscriber is only freely selected for the transfer of the relevant data packet. A subsequent data packet can be directed via another channel. Therefore it is possible for the order in which the packets are received to differ from the order in which they are sent. Since with packet oriented transmission only the starting point and the destination are determined and the connection channel varies from data packet to data packet, the connection is referred to as a virtual connection in this context.

There is an increasing demand to be able to transmit large volumes through mobile communication with a high bandwidth as well. An IP-based radio communication network was thus proposed in which connections are made by IP communication.

A radio communication system which is compatible on the one hand with radio communication systems that support connection-oriented communication and on the other hand supports mobile data communication using connectionless communication has been proposed in the older European Patent Application 01115520.7. To establish a connection between a first network element which supports connection-oriented communication, and a second network element which supports connectionless communication a connection is established between the first network element and an interworking unit and a connectionless communication established between the second network element and the interworking unit. For these connections a first signaling protocol which is assigned to the first network element and a second signaling protocol which is assigned to the second network element are used. The first signaling protocol and the second signaling protocol differ in this case by an information element which contains an address for the connectionless communication between the second network element and the interworking unit. For address resolution it is necessary in the proposed radio communication system for a conversion table to be set up in each network element.

### SUMMARY OF THE INVENTION

The problem underlying the invention is that of specifying a further radio communication system and the method for its operation which on the one hand is compatible with radio communication systems which support connection-oriented communication and that on the other hand supports mobile data communication by connectionless communication and that can be implemented with less effort.

The radio communication system includes a first network element which supports connection-oriented communication and to which a first address in a first format is allocated, and a second network element that supports connectionless communication and to which a second address in a second format is allocated. Further the radio communication system includes an interworking unit and a database. To establish a connection between the first network element and the second network element a connection is set up between the first network element and the interworking unit and connectionless communication is established between the interworking unit and the second network element. In this case addresses are converted from the first format into the second format with the aid of the database.

In accordance with the invention address tables of stored centrally in the database and enable addresses in the first format to be converted into addresses in the second format and vice-versa. By storing address tables centrally the different network elements can access the database and it is not necessary to store the address tables in each network element. This significantly simplifies implementation. It also simplifies data maintenance.

Preferably at least one server is provided in which the database is stored.

As regards redundancy and interchange of information between various domains it is advantageous to store the database in the sense of a distributed database at a plurality of storage locations.

It is within the framework of the invention, for establishing the connection between the first network element and the second network, to send a radio connection query over a signaling channel from the first network element to the second network element. The second network element responds to the radio connection query by sending a request to the database to establish its address in the first format. The second network element sends its address in the first format as a response to the first network element to make it possible for the latter to establish a connection for the transmission of payload data. The connection between the first network element and the interworking unit is established, in which case the interworking unit is notified about the address of the second network element in the first format. The interworking unit uses a query to the database to determine the address of the second network element in the second format which gives the interworking unit the opportunity to determine the destination of the connection setup. With the aid of the address of the second network element in the second format connectionless communication is created between the interworking unit and the second network element.

It is within the framework of the invention, for establishing communication between the first network element and the second network, to send a radio connection request over a signaling channel from the second network element to the first network element. The first network element sends its address in the first format as a response to the second network element. The second network element uses a query to the database to determine the address of the interworking unit in the second format which can establish a connection with the first network element. By using this address in the second format connectionless communication is created between the second network element and the interworking unit. The connection between the interworking unit and the first network element is established using the address of the first network element in the first format.

The invention can advantageously be used in a radio communication system in which the first network element supports ATM connections and the second network element supports IP communication.

In this case it is within the framework of the invention for the first network element to be allocated an A2EA (AAL-2 Endsystem Address) address, which for example is E.164-based, and for the second network element to be allocated an IP address. The database in this case includes conversion tables from A2EA addresses into IP addresses and vice versa.

It is within the framework of the invention to store the database in a server which is present in any event in the radio communication system. Particularly suitable for this purpose is a Domain Name Service (DNS) specified in IP networks by RFC1034 and RFC1035, which is typically used by TCP/IP applications for purposes such as mapping host names to IP addresses and IP addresses to host names.

It is within the framework of the invention for a plurality of interworking units, a plurality of first network elements which support connection-oriented communication and a plurality of second network elements which support connectionless communication to be provided. In this case information about which interworking unit is responsible for which first network element is also stored in the database. This is done for example by the A2EA address of the first network element being integrated into a host name. This host name is assigned the IP addresses of the interworking units responsible.

It is within the framework of the invention to define the addressing of the IP-based part of the radio communication system in such a way that it contains the associated A2EA address. To this end the A2EA address can be selected as part of the domain name or a node designation. In this case the second network element can additionally be allocated a node or domain name which contains the associated A2EA address.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of a radio communication system in accordance with the invention.

FIG. 2 is a communication timing diagram of connection setup, data transmission and connection release between an IP-based and an ATM-based radio network controller, where the ATM-based radio network controller has initiated the connection.

FIG. 3 is a communication timing diagram of connection setup, data transmission and connection release between an IP-based and an ATM-based radio network controller, where the IP-based radio network controller has initiated the connection.

FIG. 4 is a communication protocol diagram of the protocol used for connection setup between the IP-based and the ATM-based radio network controller.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

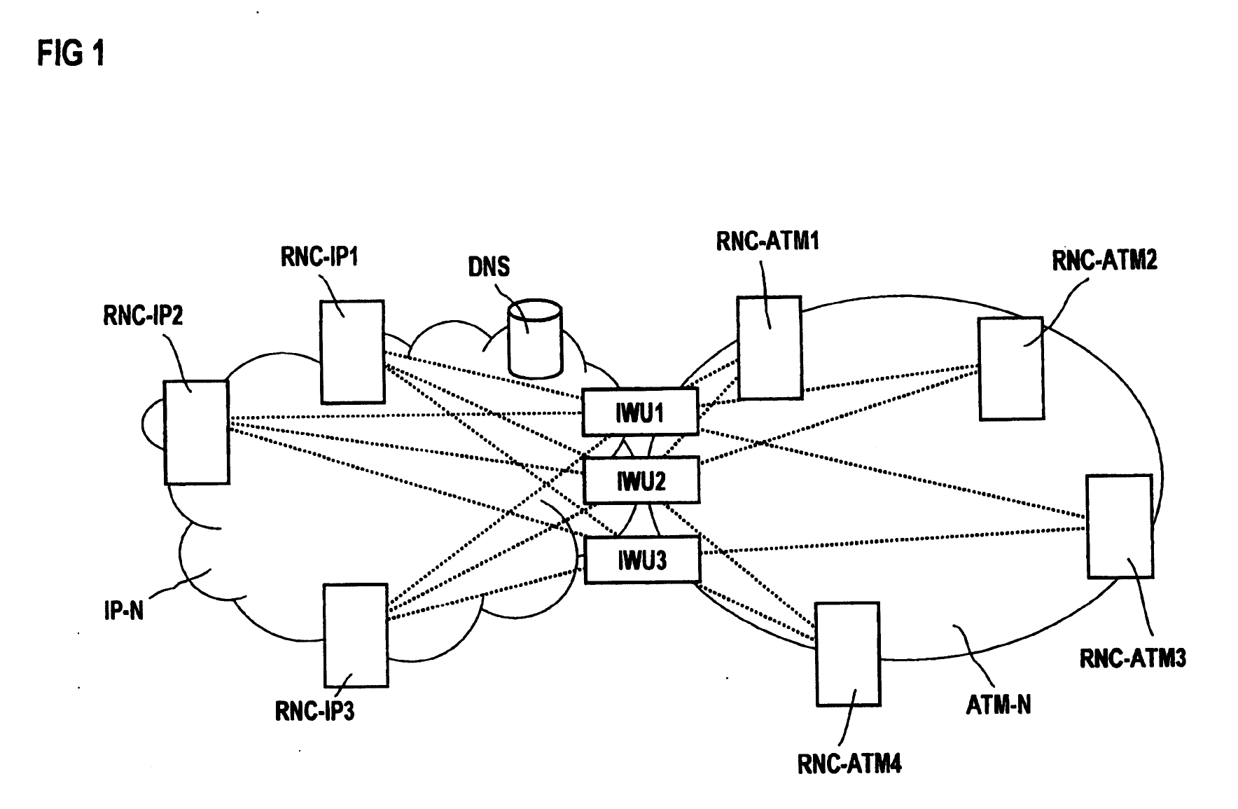

A radio communication system includes an ATM network part ATM-N and an IP-network part IP-N (see FIG. 1). In the ATM network part ATM-N four radio network controllers RNCATM1, RNC-ATM2, RNC-ATM3, RNC-ATM4 are provided which support ATM-based, that is connection-oriented communication. Each of the ATM-based radio network controllers RNC-ATMi is assigned an E.164-address.

In the IP-network part IP-N three IP-based radio network controllers RNC-IP1, RNC-IP2, RNC-IP3 are provided which support connectionless communication. Each of the IP-based radio network controllers RNC-IPi is assigned an IP address.

To allow connections between the ATM-based radio network controllers RNC-ATMi and the IP-based radio network controllers RNC-IPi interworking units IWU1, IWU2, IWU3 are provided between the ATM network part ATM-N and the IP-network part IP-N. The interworking units IWU1, IWU2, IWU3 are assigned both an IP address, and also an E.164-address in this case.

In the area of the IP network part IP-N a server DNS is provided in which address tables are stored and administered. The address tables each contain the IP address and the assigned E.164 directory number of the IP-based radio network controllers RNC-IPi. In addition the E.164-addresses of the ATM-based radio network controllers RNCATMi which are integrated into a host name are stored in the server DNS. The host name is assigned the IP address of the interworking unit or interworking units IWUi respectively in the address table which is responsible for the relevant ATM-based radio network controller RNC-ATMi.

Additional IP-network-internal names for the IP nodes can be administered in the server. What is known as the CNAME option which has been specified by the IETF is especially suited to this task.

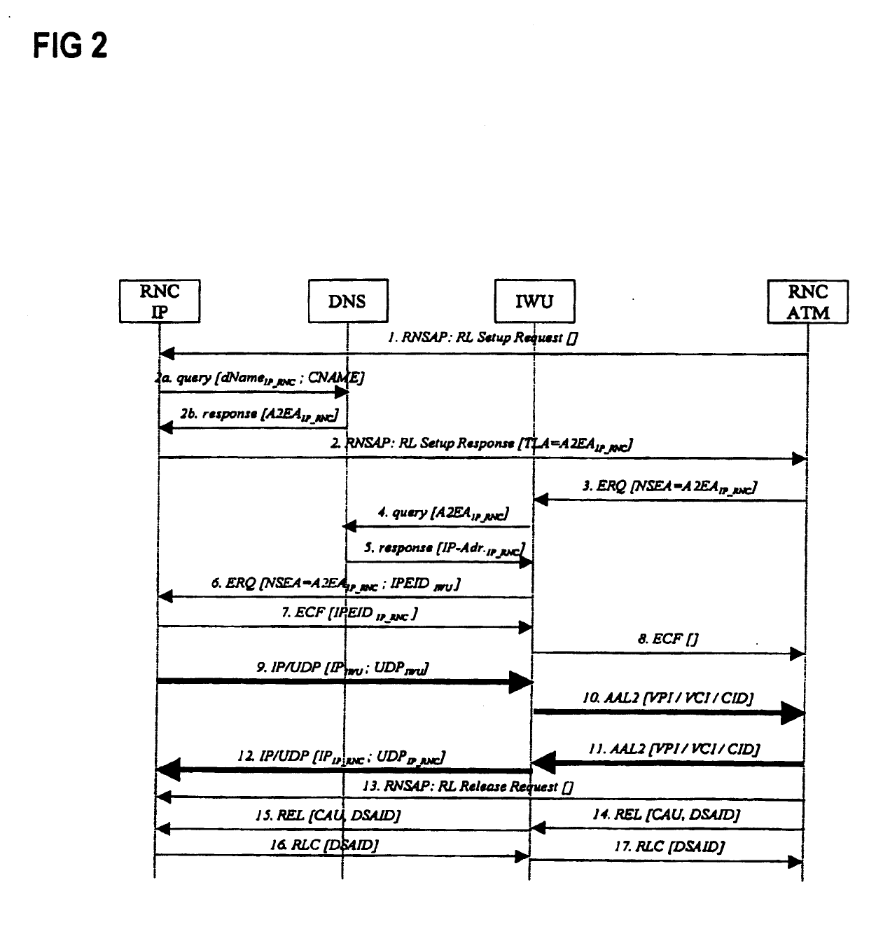

For connection setup between an ATM-based radio network controller RNC-ATM and an IP-based radio network controller RNC-IP with the collaboration of an interworking unit IWU and a server DNS the ATM-based radio network controller RNC-ATM sends a radio connection query over a signaling channel to the IP-based radio network controller (see FIG. 2). Using a query [dNAME_{IP}_{_{—}}_{RNC};CNAME] to the database server DNS the IP-based radio network controller RNCIP receives as a response [A2EA_{IP}_{_{—}}_{RNC}] its own E.164-address.

The IP-based radio network controller confirms the radio connection query and sends its E.164-address to the IP-based radio network controller RNC-ATM.

The ATM-based radio network controller RNC-ATM sets up an ATM-based ML-2 connection in accordance with the protocol standardized under the name ALCAP by ITUT under designation Q.2630.x as far as the interworking unit IWU. In this case the E.164-address of the IP-based radio network controller RNC-IP is transferred as well. The query uses an already created signaling connection between the ATM-based radio network controller RNC-ATM and the interworking unit IWU.

The interworking unit IWU submits a name query to the database server DNS in order to obtain the IP address of the IP-based radio network controller RNC-IP for the transferred E.164-address A2EAIP RNC of the IP-based radio network controller RNC-IP. The database server DNS responds with one or more IP addresses of the IP-based radio network controller RNC-IP.

Subsequently IP-based communication between the interworking unit IWU and the IP-based radio network controller RNC-IP is established. To do this an Establishment Request ERQ[NSEA=A2EA_{IP}_{_{—}}_{RNC};IPEID_{IWU}] signaling message is sent. The IP-based radio network controller RNC-IP responds with an Establishment Confirm ECF to the interworking unit IWU. The interworking unit IWU sends a further Establishment Confirm signaling message to the ATM-based radio network controller RNC-ATM. This establishes a payload data connection between the IP-based radio network controller RNC-IP and the ATM-based radio network controller RNC-ATM. Payload data, shown as black arrows in the Figures, is transmitted. The payload data between the IP-based radio network controller RNC-IP and the interworking unit IWU is transmitted over an IP/UDP connection. Between the interworking unit IWU and the ATM-based radio network controller RNC-ATM the payload data is transmitted over an ATM-based AAL2 connection.

After the end of data transmission the communication is ended again. To do this an RL Release Request for the interworking unit IWU is exchanged transparently between the ATM-based radio network controller RNC-ATM and the IP-based radio network controller RNCIP.

This is followed by the release of the connection between the ATM-based radio network controller RNC-ATM and the interworking unit IWU, as well as the ending of the connectionless communication between the interworking unit IWU and the IP-based radio network controller RNC-IR

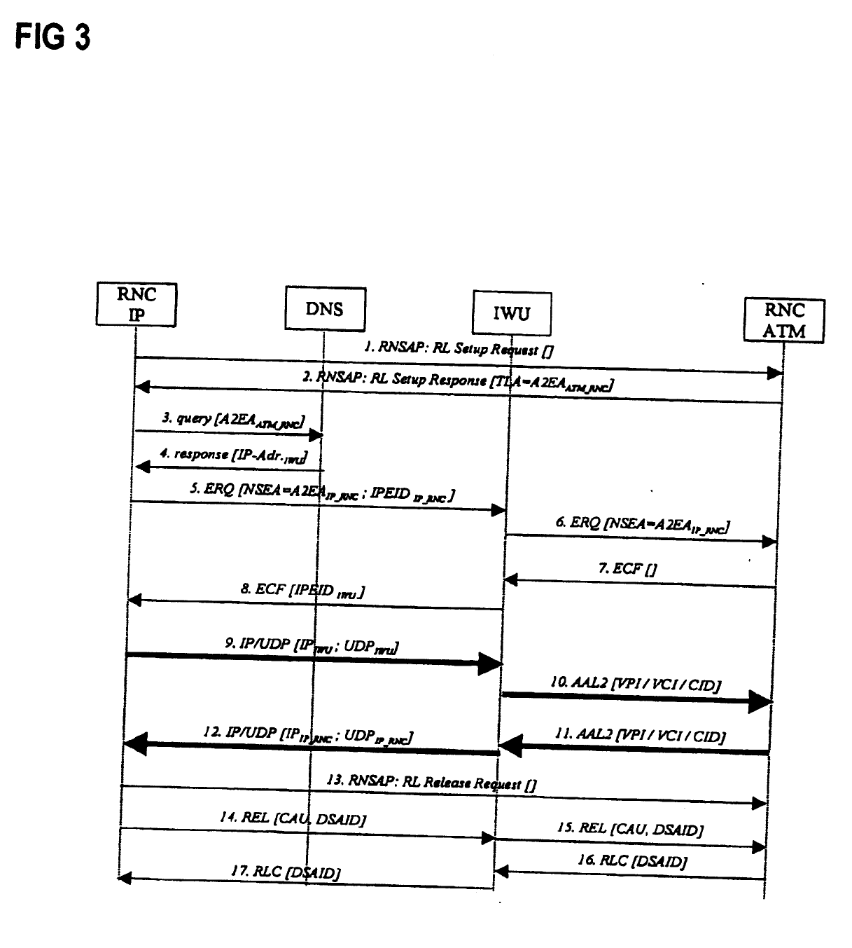

To set up communication between the IP-based radio network controller RNC-IP and the ATM-based radio network controller RNC-ATM the IP-based radio network controller RNC-IP sends a radio connection query over a signaling channel to the ATM-based radio network controller RNC-ATM (see FIG. 3). The ATM-based radio network controller RNC-ATM confirms the radio connection query and sends its E.164-address A2EA_{ATM}_{_{—}}_{RNC} as well. This address is permanently configured in the ATM-based radio network controller RNC-ATM.

The IP-based radio network controller RNC-IP submits the query to the database server DNS to obtain the associated IP address of the interworking unit IWU responsible. If the IP-based radio network controller RNC-IP and the ATM-based radio network controller RNC-ATM are located in the same domain, the IP address can be made up of the E.164-address of the ATM-based radio network controller RNC-ATM and the domain name of the IP-based radio network controller RNC-IP. Alternatively the address can be created in accordance with RFC2916, in which case subdomains can be formed.

The database server DNS responds with the IP addresses of all interworking units IWU which can establish a connection with the ATM-based radio network controller RNC-ATM. The IP-based radio network controller RNC-IP has the opportunity at this point of undertaking load sharing.

The IP-based radio network controller RNC-IP sets up connectionless communication to interworking unit IWU, in which case a protocol is used which corresponds to the protocol standardized under the name ALCAP for establishing ATM-based connections and which additionally contains an IP endpoint identification for establishing communication between the IP-based radio network controller RNC-IP and the interworking unit IWU. In this case the E.164-address of the ATM-based radio network controller RNC-ATM is transferred as well. The query uses an already-established signaling connection between the IP-based radio network controller RNC-IP and the interworking unit IWU.

Subsequently an Establishment Request ERQ[NSEA=A2EA_{ATM}_{_{—}}_{RNC}] signaling message is sent from the interworking unit IWU to the ATM-based radio network controller to which the response is an Establishment Confirm ECF. There follows an Establishment Confirm ECF[IPEID_{IWU}] of the interworking unit IWU to the IP-based radio network controller RNC-IP. Thus communication from the IP-based radio network controller RNCIP to the ATM-based radio network controller RNC-IP and vice-versa is established. Payload data, shown as black arrows in the Figures, is transmitted. The payload data is transmitted between the IP-based radio network controller RNC-IP and the interworking unit IWU by IP/UDP communication. Between the interworking unit IWU and the ATM-based radio network controller RNC-ATM the payload data is transmitted over an ATM-based AAL2 connection.

At the end of data transmission the radio connection is released again. To do this a RL Release Request is exchanged transparently for the interworking unit IWU between the IP-based radio network controller RNC-IP and the ATM-based radio network controller RNC-ATM. This is followed by the ending of communication between the IP-based radio network controller RNC-IP and the interworking unit IWU as well as release of the connection between the interworking unit IWU and the ATM-based radio network controller RNC-ATM.

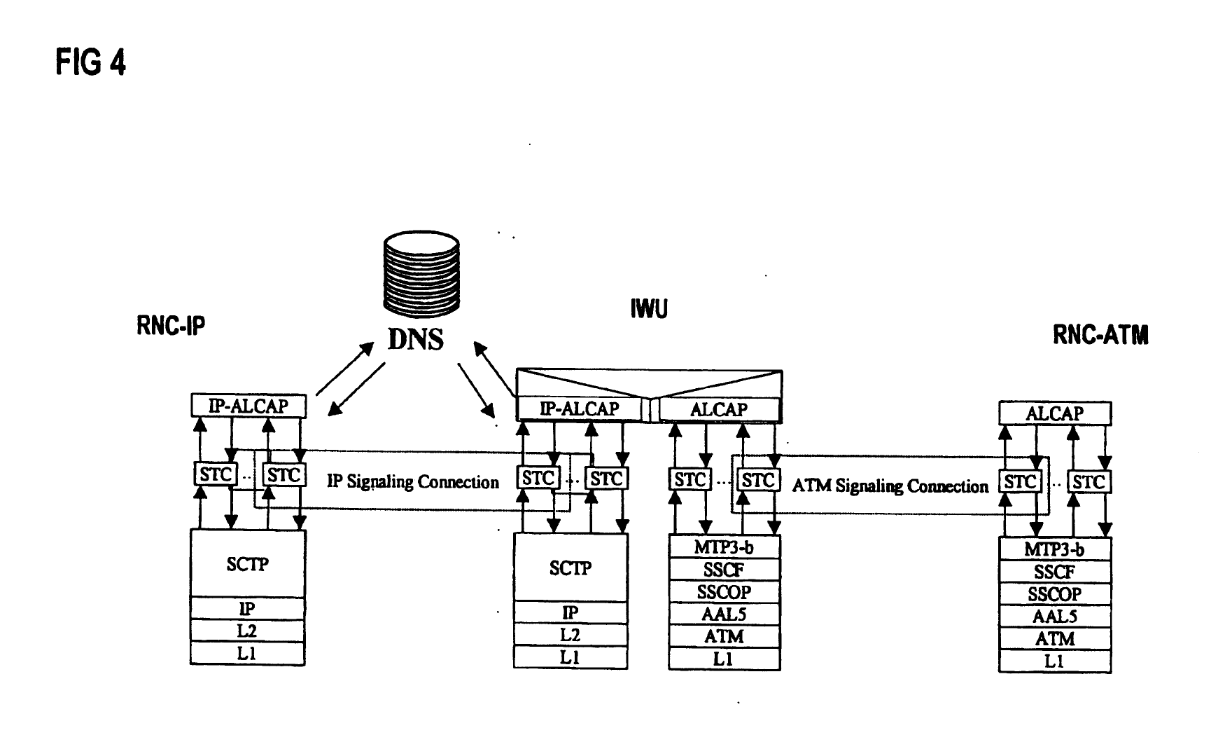

FIG. 4 shows the protocols used for this. Connection setup is based on the standardized protocol for the ATM-based radio network controller called ALCAP from ITU-T under the designation Q.2630.x for establishing ATM-based connections with E.164 addresses which contains the ALCAP of the higher layers (RNL, Radio Network Layer). Connection setup for the interworking unit IWU and the IP-based radio network controller RNC-IP is undertaken ion the basis of the ALCAP which is expanded by an IP endpoint ID. During the initialization of each node signaling connections are established to the interworking unit IWU.

In the layers below this Signaling Transfer Converters STC are provided which each represent precisely one signaling connection to a corresponding node. In ATM-based nodes Signaling Transfer Converter STC is linked to the ALCAP via Point Code addresses of the SS7 signaling network below it. An assignment table is stored in each radio network controller which assigns the E.164 address of a radio network controller to the point code of the node to which the ML-2 messages are to be sent. The ALCAP can thus use the E.164 address to directly select the corresponding Signaling Transfer Converter and thereby the signaling connection. In IP-based nodes the Signaling Transfer Converter STC is linked via an IP address to the ALCAP. The E.164 address is converted into an IP address by a request to the database server DNS within the ALCAP.

In the method described the Signaling Transfer Converters STC must be configured in the IP-based nodes for all nodes which can potentially be reached in the ATM-based network part. Since all connections are realized via the interworking unit IWU as many STC links must be configured in the IP-based nodes as there are interworking units IWU provided. Changes in the ATM-based network part are undertaken by adapting the database in the database server DNS.

The invention has been described in detail with particular reference to preferred embodiments thereof and examples, but it will be understood that variations and modifications can be effected within the spirit and scope of the invention.

1-18. (cancelled).

19. A radio communication system, comprising:
at least one first network element supporting connection-oriented communication and correspondingly identified by at least one first address in a first format;
a second network element supporting connectionless communication and identified by a second address in a second format;
at least one interworking unit, respectively establishing communication between said at least one first network element and said second network element by establishing a connection with said at least one first network element and establishing connectionless communication with said second network element; and
a database storing information about correspondence between said at least one interworking unit and said at least one first network element and aiding conversion of addresses between the first and second formats.

20. A radio communication system in accordance with claim 19, further comprising at least one server accessing said database.

21. A radio communication system in accordance with claim 20, wherein said database is a distributed database at a plurality of locations.

22. A radio communication system in accordance with claim 21,
wherein communication between said at least one first network element and said second network element is initiated by sending a radio connection query over a signaling channel from said at least one first network element to said second network element,
wherein said second network element determines the second address in the first format using a first database query to said database for sending to said at least one first network element in response to the radio connection query,
wherein said interworking unit is notified of the second address in the first format via the connection between said first network element and said interworking unit and uses a second database query to determine the second address in the second format, and then establishes the connectionless communication with said second network element.

23. A radio communication system in accordance with claim 21,
wherein said second network element sends a radio connection query over a signaling channel to said at least one first network element to establish the communication between the first network element and the second network element,
wherein said at least one first network element sends to said second network element the first address in the first format in response to the radio connection query,
wherein said second network element uses a query to the database to determine a third address in the second format of said at least one interworking unit which can establish a connection with said at least one first network element and then establishes connectionless communication with said interworking unit, and
wherein said at least one interworking unit establishes the connection with said at least one first network element.

24. A radio communication system in accordance with claim 23,
wherein said at least one first network element supports asynchronous transfer mode connections, and
wherein said second network element supports Internet protocol communication.

25. A radio communication system in accordance with claim 24,
wherein each first network element is allocated an asynchronous transfer mode adaptation layer-2 endsystem address,
wherein said second network element is allocated an Internet protocol address,
wherein said database includes conversion tables for converting between asynchronous transfer mode adaptation layer-2 endsystem addresses and Internet protocol addresses.

26. A radio communication system in accordance with claim 25, wherein said second network element is additionally allocated a node or domain name which contains an associated asynchronous transfer mode adaptation layer-2 endsystem address.

27. A radio communication system in accordance with claim 19,
wherein communication between said at least one first network element and said second network element is initiated by sending a radio connection query over a signaling channel from said at least one first network element to said second network element,
wherein said second network element determines the second address in the first format using a first database query to said database for sending to said at least one first network element in response to the radio connection query,
wherein said interworking unit is notified of the second address in the first format via the connection between said first network element and said interworking unit and uses a second database query to determine the second address in the second format, and then establishes the connectionless communication with said second network element.

28. A radio communication system in accordance with claim 19,
wherein said second network element sends a radio connection query over a signaling channel to said at least one first network element to establish the communication between the first network element and the second network element,
wherein said at least one first network element sends to said second network element the first address in the first format in response to the radio connection query,
wherein said second network element uses a query to the database to determine a third address in the second format of said at least one interworking unit which can establish a connection with said at least one first network element and then establishes connectionless communication with said interworking unit, and
wherein said at least one interworking unit establishes the connection with said at least one first network element.

29. A method for operating a radio communication system, comprising:
establishing a connection between at least one first network element, supporting connection-oriented communication and identified by a first address in a first format, and a second network element, supporting connectionless communication and identified by a second address in a second format, by establishing a connection between the at least one first network element and at least one interworking unit and connectionless communication between the at least one interworking unit and the second network element; and
converting at least one of the first and second addresses from the first format into the second format using a database also storing information about correspondence between the at least one interworking unit and the at least one first network element.

30. A method in accordance with claim 29, wherein the database is stored on at least one server.

31. A method in accordance with claim 30, wherein the database is a distributed database stored at a plurality of storage locations.

32. A method in accordance with claim 31, wherein said establishing comprises:
sending a radio connection query over a signaling channel from the at least one first network element to the second network element;
determining, by the second network element, the second address in the first format using a database query to the database;
sending the second address in the first format from the second network element as a response to the radio connection query from the at least one first network element;
notifying the at least one interworking unit of the second address in the first format via the connection between the first network element and the interworking unit;
querying the database by the at least one interworking unit to determine the second address in the second format; and
establishing the connectionless communication between the at least one interworking unit and the second network element.

33. A method in accordance with claim 31, wherein said establishing comprises:
sending a radio connection query over a signaling channel from the second network element to the at least one first network element;
sending the first address in the first format from the at least one first network element as a response to the radio connection query from the second network element;
determining, by the second network element, a third address in the second format of the at least one interworking unit capable of establishing a connection with the at least one first network element, using a database query to the database;
establishing the connectionless communication between the second network element and the at least one interworking unit; and
establishing the connection between the at least one interworking unit and the at least one first network element.

34. A method in accordance with claim 33,
wherein the at least one first network element supports asynchronous transfer mode connections,
wherein the second network element supports Internet protocol communication

35. A method in accordance with claim 34,
wherein each first network element is allocated an asynchronous transfer mode adaptation layer-2 endsystem address,
wherein the second network element is allocated an Internet protocol address,
wherein the database includes conversion tables for conversion between asynchronous transfer mode adaptation layer-2 endsystem addresses and Internet protocol addresses.

36. A method in accordance with claim 35, wherein the second network element is additionally allocated a node or domain name with an associated asynchronous transfer mode adaptation layer-2 endsystem address.

37. A method in accordance with claim 29, wherein said establishing comprises:
sending a radio connection query over a signaling channel from the at least one first network element to the second network element;
determining, by the second network element, the second address in the first format using a database query to the database;
sending the second address in the first format from the second network element as a response to the radio connection query from the at least one first network element;
notifying the at least one interworking unit of the second address in the first format via the connection between the first network element and the interworking unit;
querying the database by the at least one interworking unit to determine the second address in the second format; and
establishing the connectionless communication between the at least one interworking unit and the second network element.

38. A method in accordance with claim 29, wherein said establishing comprises:
sending a radio connection query over a signaling channel from the second network element to the at least one first network element;
sending the first address in the first format from the at least one first network element as a response to the radio connection query from the second network element;
determining, by the second network element, a third address in the second format of the at least one interworking unit capable of establishing a connection with the at least one first network element, using a database query to the database;
establishing the connectionless communication between the second network element and the at least one interworking unit; and
establishing the connection between the at least one interworking unit and the at least one first network element.
